(19) United States
(12) Patent Application Publication
(10) Pub. No.: US 2018/0057326 A1
(43) Pub. Date: Mar. 1, 2018

(54) LOAD TRANSFERRING AND SELF-ADJUSTING SADDLE SYSTEM FOR FLOOR JACKS AND JACK STANDS APPARATUS AND METHOD

(71) Applicant: M. Jamin Loveless, Las Vegas, NV (US)

(72) Inventor: M. Jamin Loveless, Las Vegas, NV (US)

(21) Appl. No.: 15/684,176

(22) Filed: Aug. 23, 2017

Related U.S. Application Data
(60) Provisional application No. 62/378,862, filed on Aug. 24, 2016.

(51) Int. Cl. B66F 5/02

(52) U.S. Cl. CPC B66F 5/02

(57) ABSTRACT

A system for lifting a load and being able to transfer the load from a lifting device to a support structure and back to the lifting device, all while utilizing the same lift point on the load. The system includes a saddle that is removable and transferrable between the lifting device and the support structure, which does not add to the base height or mechanical complexity of the system as a whole. Thus, the saddle may engage the load and the load may be safely and conveniently transferred between the lifting device and support structure, all while the saddle remains essentially stationary.

### RELATED APPLICATIONS

This application claims the benefit of U.S. Provisional Patent Application Ser. No. 62/378,862, filed on Aug. 24, 2016, which is hereby incorporated by reference in its entirety.

### BACKGROUND

### 1. The Field of the Invention

The invention relates to an apparatus, or system that includes multiple structures, and a method used to raise a vehicle or other load from the ground with a floor jack, be it hydraulic, screw type, or other, and then allow the load to be transferred to a jack stand or similar support structure.

### 2. Background

There are many reasons a car, or other vehicle, may need to be elevated. For example, a car may need to be elevated to facilitate changing a tire, replacing brake pads, or some other maintenance. A trailer or any other wheeled vehicle may need to be elevated for similar reasons.

The traditional methods require a user to locate a suitable support location for support structures (i.e., jack stands) under the load or vehicle while the load or vehicle is supported by a lifting device (i.e., an hydraulic jack of some sort) at the factory recommended lifting points. This is complicated by the fact that certain makes of cars are designed with only one safe, suitable lift point under the vehicle (e.g., all 1997 and later models of CORVETTE®) making the transfer of the vehicle from a lifting device to a suitable support structure especially difficult. Other designs currently seeking to address this issue possess inherent limitations that decrease their usability and appeal. Some may involve complex and/or proprietary construction techniques. Some may add to the base height of the lifting apparatus or jack, thereby limiting their ability to get under vehicles or loads that have limited ground clearance. This can be made even more problematic for a car that has a flat tire. Others utilize a design that spreads the lifting surface over a wider area than the car manufacturer intended, or are too wide to access the best location for a support or jack stand.

Any garage mechanic or car enthusiast is familiar with the frustration involved with traditional methods for elevating, raising, and supporting a vehicle. For example, having to move under a car supported only by a jack in order to find a suitable location for jack stands is inherently dangerous and can be time consuming. Moreover, as described with certain vehicles, such a process can be extremely difficult or even impossible as the structure is intended to be held only by the dedicated, recommended lift points, which become inaccessible for a stand when being used or occupied by the jack itself.

Traditional methods of lifting a vehicle also often cause damage to the underside of the vehicle due to the shifting of the angle of the load as the vehicle is raised, causing the load to be borne at an edge or corner of the lifting surface, rather than having the weight evenly distributed over the entire lifting surface. Additionally, once a stand is in place, lifting the other side of the vehicle will cause the stand to unbalance as the load shifts back, often necessitating the dangerous need to “tap” the first stand back into place with a hammer after the load is raised and supported on two stands.

It would be an advance in the art to have a relatively simple mechanical structure or system designed to easily facilitate the transfer of a load or vehicle from a lifting device to a suitable support structure. It would be an advance in the art to provide a new solution that is more accommodating to the average user, less expensive to manufacture, mechanically simpler, and more flexible in its adaptation for various types of jacks and lifting mechanisms. It would also be an advance in the art to provide these advantages with a system that occupies minimal space beneath the vehicle or other load, where working space is often at a premium.

It would be an advance in the art to have a system that is able to be implemented with a reduced minimum base height, thereby enabling the system to be used with vehicles or loads that have limited ground clearance.

It would be an advance in the art to have a system that is able to accommodate or adjust for the tilting of a load or vehicle and resultant edge loading that happens when one side of the load is lifted, and will adjust for the resultant tilting of the first jack stand when a user lifts the other side of the load.

### BRIEF SUMMARY OF THE INVENTION

The present invention or system described herein may include a support stand and a jack or lifting device, where both the support stand and the lifting device are compatible with an adjustable, removable, and transferable saddle.

In certain embodiments of the invention, a support stand may have a base that is capable of straddling the lifting device. In other embodiments, the lifting device or jack may be built in such a manner that it surrounds the base or stand rather than fitting beneath it. Thus, in either arrangement, the support stand may be positioned under the load while the lifting device is lifting or supporting the load from a specific lifting point.

In certain embodiments of the invention, a support stand may be extendable, or telescopic, and capable of supporting a load at a variety of heights.

In certain embodiments of the invention, a load bearing lifting surface, load bearing saddle, and support mechanism for a jacking apparatus, compatible with current standard production of various jacks and jack stands, which allow the load-bearing saddle to be securely locked in place while under load and removed from the lifting surface and transferred to the additional support while under load. The lifting surface may include a system of slots, holes, and chamfers allowing the saddle to be secure under load and released under load without additional complex mechanical systems, and the saddle may have extrusions and machining that engages said lifting surface to be secure under load, but which also allows the saddle to engage the secondary support and be released by the lifting surface while under load, the support mechanism likewise may have machining allowing it to securely engage the saddle and retain it after the lifting surface is released.

One embodiment of the invention may include a new design for the lifting surface, saddle, saddle pocket, and jack stand load interface, which allows the saddle to be easily transferred from the lifting mechanism to the support mechanism while under load, and then left there. This allows the support to be placed and engage the saddle at the lift point on the load. The saddle may then be re-engaged by the lift and removed from the support when no longer needed, allowing the support to be removed and the load lowered. One embodiment of the invention may include a saddle, and/or saddle pocket, configured to fit onto a support peg in a manner that allows the saddle to wobble, rotate, tilt, swivel, angle, pivot, or the like, and remain removable.

In certain embodiments, a load bearing component may interface securely with both a lifting device and the support stand or support structure, but the load bearing component is not permanently attached to either the lifting device or the support stand. This allows an essentially static load to be transferred from the lifting device to the support stand or support structure and back again without requiring the load to be moved from one place to another, while being securely retained throughout the process.

In one embodiment, a support stand apparatus may comprise a trunk of a support stand, a support peg connected to the trunk and configured to allow removable connection to a compatible, saddle pocket, indentation, hole, or slot in the underside of a transferable saddle, and the pocket, indentation, hole, or slot in the underside of the saddle configured so as to allow the transferable saddle to wobble while remaining removably connected to the support peg, and while the transferable saddle remains fully engaged with the lift point of a load.

In other embodiments, the transferable saddle may further comprise a hemispherical, rounded, convex saddle base including a beveled saddle pocket, or a mushroom-shaped saddle pocket. Also, the trunk of the support stand may further comprise means for adjusting the overall height of the support stand and locking the support stand into a desired position.

In one embodiment, a method for transferring a load from a lifting device to a support stand may comprise providing a lifting device, wherein the lifting device comprises a jack head, and the jack head comprises a concave bowl and a jack head aperture, providing a transferrable saddle, wherein the transferable saddle comprises a convex saddle base and a beveled saddle pocket, positioning the transferable saddle on the jack head such that the rounded saddle base is positioned in the concave bowl, positioning the transferable saddle under a lift point on a load to be lifted, operating the lifting device to elevate the transferable saddle so the transferable saddle engages the lift point, lifting the load, providing a support stand comprising a support peg, positioning the support peg of the support stand under the beveled saddle pocket of the transferable saddle, and lowering the load onto the support stand by removably connecting the beveled saddle pocket of the transferable saddle and the support peg.

Other embodiments may further comprise disengaging the lifting device from the transferable saddle.

In other embodiments, the beveled saddle pocket may be a mushroom saddle pocket. Also, the step of positioning the transferable saddle on the jack head may further comprise allowing the transferable saddle to wobble while on the jack head. Also, the step of lowering the load may further comprise wobbling of the transferable saddle as the load is lowered. Also, the step of lowering the load further comprises the wobbling of the transferable saddle as it interlocks with the peg on the support or stand resulting in a locking of the transferable saddle to the support or jack stand.

In other embodiments, the support stand may further comprise means for adjusting the overall height of the support stand. Also, the support stand may be a monolithic, contiguous unit. Also, the support stand may be configured to straddle at least a portion of the lifting device.

In one embodiment, a method for transferring a load from a lifting device to a support stand may comprise providing a lifting device, wherein the lifting device comprises a jack head, and the jack head comprises a concave bowl and a jack head aperture, providing a first transferrable saddle, wherein the first transferable saddle comprises a first convex saddle base and a first beveled saddle pocket, positioning the first transferable saddle on the jack head such that the first convex saddle base is positioned in the concave bowl in a manner that allows the first transferable saddle to tilt and rotate while on the jack head and the beveled saddle pocket is aligned with at least a portion of the jack head aperture, positioning the lifting device under a load to be lifted such that the first transferable saddle on the jack head is positioned under a first lift point on the load, operating the lifting device to elevate the first transferable saddle so that the first transferable saddle engages the first lift point, lifting the load, providing a first support stand comprising a first support peg, positioning the first support peg of the first support stand under the first beveled saddle pocket of the first transferable saddle, lowering the load onto the first support stand by removably connecting the first beveled saddle pocket and the first support peg in a manner that results in some tilting of the first transferable saddle, and disengaging the lifting device from the first transferable saddle.

In one embodiment a similar method may comprise providing the lifting device, providing a second transferable saddle, wherein the second transferable saddle comprises a second convex saddle base and a second beveled saddle pocket, positioning the second transferable saddle on the jack head such that the second convex saddle base is positioned in the concave bowl in a manner that allows the second transferable saddle to tilt and rotate while on the jack head and the second beveled saddle pocket is aligned with at least a portion of the jack head aperture, positioning the lifting device under the load such that the second transferable saddle on the jack head is positioned under a second lift point on the load, operating the lifting device to elevate the second transferable saddle so that the second transferable saddle engages the second lift point, lifting the load, providing a second support stand comprising a second support peg, positioning the second support peg of the second support stand under the second beveled saddle pocket of the second transferable saddle, lowering the load onto the second support stand by removably connecting the second beveled saddle pocket and the second support peg in a manner that results in some tilting of the second transferable saddle, and disengaging the lifting device from the second transferable saddle.

In other embodiments, a method may comprise repeating the foregoing process with a third support device (jack stand) and a third transferable saddle base while the first and second support devices (jack stands) are in place, thereby reducing or eliminating any material lateral load on the first and second jack stands as the third jack stand is put in place; and a method may similarly comprise repeating the foregoing process with a fourth support device (jack stand) and a fourth transferable saddle while the first, second, and third support devices (jack stands) are in place, thereby reducing or eliminating any material lateral load on the first, second, and third jack stands as the fourth jack stand is put in place.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through the use of the accompanying drawings in which:

FIG. 1 is a front elevation view of a support stand;

FIG. 2 is a perspective view of a support stand;

FIG. 3 is a perspective view of a support stand;

FIG. 4 is a perspective view of a support stand with a saddle;

FIG. 5 is a side elevation view of a saddle;

FIG. 6 is a bottom view of a saddle;

FIG. 7 is a top view of a jack head;

FIG. 8 is perspective view of a jack with a saddle;

FIG. 9 is a perspective view of a jack and a support stand and a saddle;

FIG. 10 is a perspective view of a support stand and saddle;

FIG. 11 is a perspective view of a support stand and saddle and a load (in ghost);

FIG. 12a is a side view of a transferable saddle;

FIG. 12b is a perspective view of a jack;

FIG. 12c is a side view of a portion of a jack stand;

FIG. 13a is a cut-away side view of a saddle configuration;

FIG. 13b is a cut-away side view of a saddle configuration;

FIG. 14a is a cut-away side view of a saddle and jack stand configuration; and

FIG. 14b is a cut-away side view of a saddle and jack stand configuration.

FIG. 15 is a schematic block diagram of a method for using the system described herein.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

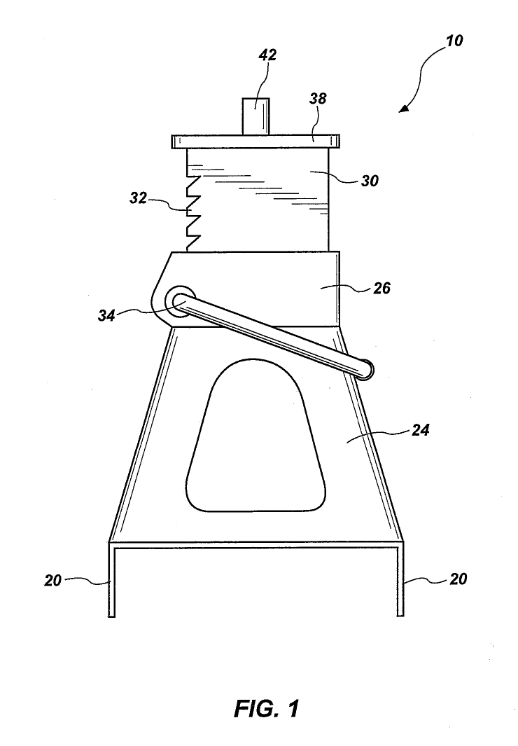

Referring to FIG. 1, a support stand 10, or support structure 10 or jack stand 10, may include various parts, or sections. The support stand 10 may include a base 20 that contacts the ground or floor. The base 20 may include two faces on opposite sides of the support stand 10 and spaced apart to form a base alley 22, or a space between the faces of the base 20. The base alley 22 is spaced apart between approximately two (2) inches and twenty (20) inches. The base alley 22 provides a space where the base 20, and thereby the support stand 10, may straddle a portion of a lifting device in a manner that allows the support stand 10 to be placed under a lifting point or a lifting structure (i.e., a saddle) of the lifting device. The base 20 may be composed of any suitable material, including without limitation, steel, aluminum, plastic, or the like.

The support stand 10 may include a body 24 that provides a measure of structural support on top of the base 20. The body 24 may have a variety of configurations or cross-sections, including without limitation, square, rectangular, circular, or the like. The body 24 may be composed of any suitable material, including without limitation, steel, aluminum, plastic, or the like.

The support stand 10, or jack stand 10, may include a collar 26 that provides additional structural support on top of the body 24 and provides a track, channel, or containment where the stem 30 can be contained and supported. The stem 30 may also slide within the collar 26. The collar 26 may have a variety of configurations or cross-sections, including without limitation, square, rectangular, circular, or the like. However, the configuration or cross-section of the collar 26 should be compatible with or match the configuration or cross-section of the stem 30 so as to allow the intended sliding of the stem 30 within the collar 26. The collar 26 may be composed of any suitable material, including without limitation, steel, aluminum, plastic, or the like.

The base 20, body 24, and collar 26 of a support stand 10 may be composed a single integrated, monolithic, continuous, or contiguous section or part of the support stand 10. The base 20, body 24, and collar 26 of a support stand 10 may also be described as a trunk of the support stand 10. A trunk may provide the necessary support for the support stand 10 while being configured to allow the support stand 10 to operate in its intended manner. The trunk may be composed of any suitable material, including without limitation, steel, aluminum, plastic, or the like.

The support stand 10 may include a stem 30 that provides a structure that enables the overall height of the support stand 10 to be adjusted. Various means may be used to enable the overall height of the support stand 10 to be adjusted. For example, the stem 30 may have a variety of configurations or cross-sections, including without limitation, square, rectangular, circular, or the like. However, the configuration or cross-section of the stem 30 should be compatible with or match the configuration or cross-section of the collar 26 so as to allow the intended sliding of the stem 30 within the collar 26. The stem 30 may be composed of any suitable material, including without limitation, steel, aluminum, plastic, or the like.

In one embodiment, the stem 30 may include teeth 32 on one face or side of the stem 30. The teeth 32 are configured to interact with a locking pin, or some other mechanism, that enables the stem 30 to be adjustable in either direction and lockable in virtually any position. The locking pin may be operated by an adjustment handle 34, or some other suitable means.

In one embodiment, the stem 30 may include apertures, or holes, arrayed along the length of the stem 30 and configured to be lined up with corresponding holes through the collar 26 so as to allow a cotter pin, or similar structure, to be driven through the collar 26 and the stem 30, thus securing the position of the stem 30 with respect to the collar 26.

The stem 30 may include a stem surface 38 at the top end, or proximal end, of the stem 30. The stem surface 38 provides a surface or area where a saddle 40, or more specifically a saddle cup 44, may be secured to the top end, or proximal end, of the stem 30. The stem surface 38 may be of any suitable size or shape, including without limitation, square, rectangular, circular, or the like. The stem surface 38 may be composed of any suitable material, including without limitation, steel, aluminum, plastic, or the like.

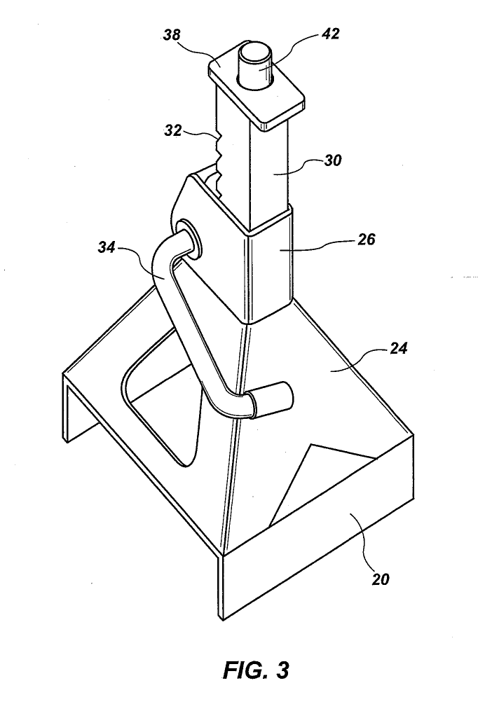

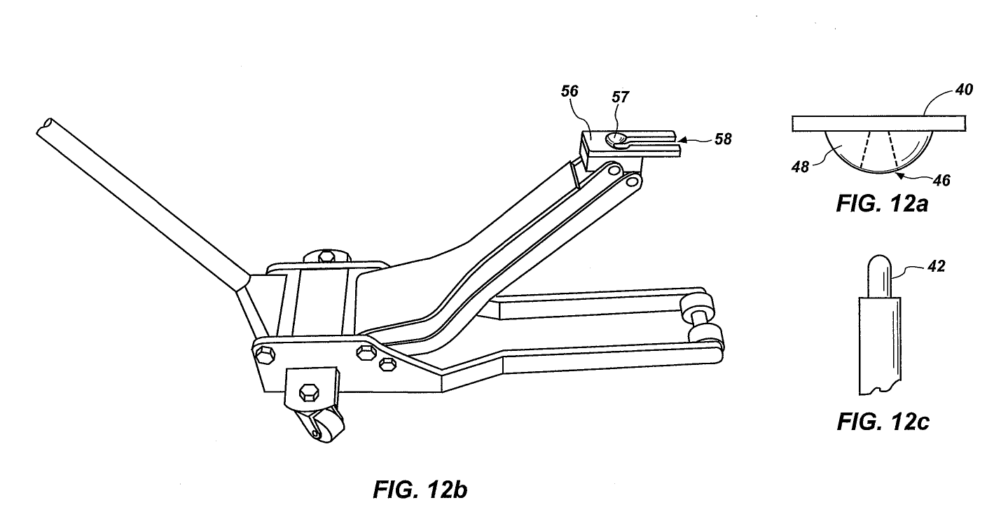

The stem surface 38 may include a support peg 42, or saddle peg 42, that is positioned to interact with the saddle cup 44 and allow a more secure attachment between the saddle 40 and the stem 30, and thereby the support stand 10, or trunk. The support peg 42 may be of any suitable shape or cross-section, including without limitation, cylindrical, rectangular, circular, or the like. The support peg 42 may be substantially flat (as shown in FIG. 3) or rounded (as shown in FIG. 12) or any suitable configuration. The support peg 42 may be of varying lengths to accommodate different configurations of transferable saddles 40. The support peg 42 may be composed of any suitable material, including without limitation, steel, aluminum, plastic, or the like.

In one embodiment, a support stand 10 may be composed as a single integrated, monolithic, continuous, or contiguous support stand 10, or unit.

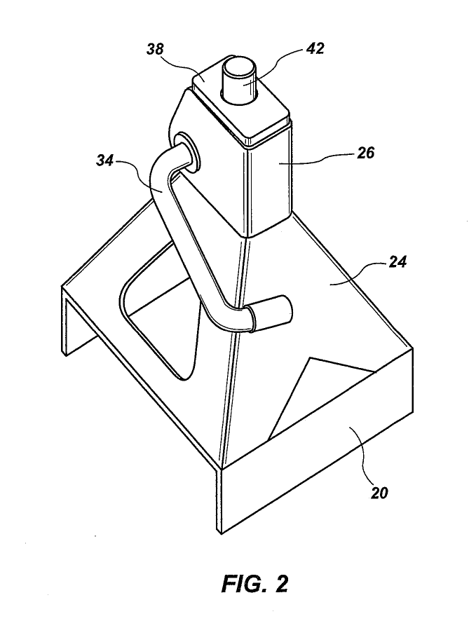

Referring to FIG. 2, the support stand 10 is shown with the stem 30 not extended, or in other words, with the stem surface 38 sitting on top of the collar 26. This may be described as the minimum overall height of the support stand 10 for a support stand 10 configured as described.

Referring to FIG. 3, the support stand 10 is shown with the stem 30 in an extended position. The stem 30 is lockable and un-lockable by means of the teeth 32, locking pin (not shown), and adjustment handle 34. Thus, the overall height of the support stand 10 is adjustable by sliding the stem to the desired height and then allowing the teeth 32 to lock the stem 30 into place. The stem 30 is configured to be adjustable and lockable so as to enable the overall height of the support stand 10 to be adjustable.

Generally, the support stand 10 will have a minimum overall height corresponding to the approximate height of the trunk and a maximum overall height corresponding to the approximate height of the trunk plus the stem 30 when the stem 30 is in its most extended position. The minimum overall height of a support stand 10 may be between approximately six (6) inches and twelve (12) inches. The maximum overall height of a support stand 10 may be between approximately eight (8) inches and thirty-six (36) inches.

Referring to FIG. 4, the support stand 10 is shown with one embodiment of a saddle 40 sitting on top of the stem 30, or more specifically, the saddle peg 42, or support peg 42, is inside a cylindrical indentation or hole in the cylindrical saddle pocket 44 and the inner top face of the cylinder, indentation or hole in the cylindrical saddle pocket may be sitting on the support peg 42, and/or the rim of the cylindrical saddle pocket may sit on the stem surface 38. The term “saddle pocket” may describe a variety of saddle pocket shapes or configurations, including without limitation, a cylindrical saddle pocket 44, a conical saddle pocket 46, and a mushroom saddle pocket 47. A cylindrical saddle pocket 44 may be configured so as to engage with a support peg 42 in a manner that does not allow much movement between the saddle 40 and support peg 42.

The transferable saddle 40 is configured to be removable from the stem 30, and/or support peg 42, and/or stem surface 38. The saddle 40 and cylindrical saddle pocket 44 may be configured in a manner that does not allow much movement between the saddle 40 and the support peg 42. For example, the shape of the cylindrical saddle pocket 44 may be formed to substantially align with the shape of the support peg 42. The rim of the cylindrical saddle pocket 44 may also rest on the stem surface 38 to provide additional stability.

The transferable saddle 40 may be of any suitable shape or cross-section, including without limitation, conical, cylindrical, rectangular, circular, or the like. The saddle 40 may be composed of any suitable material, including without limitation, steel, aluminum, plastic, or the like.

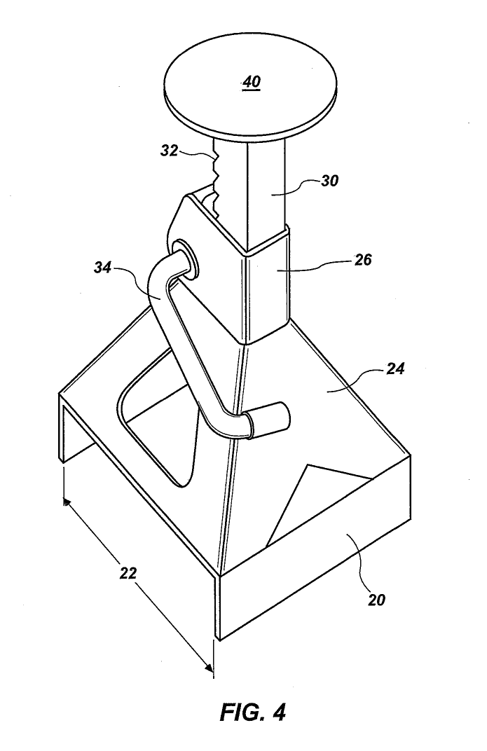

Referring to FIG. 5, a transferable saddle 40, or just saddle 40, is shown in a side view to illustrate an embodiment where the saddle 40 has a somewhat conical shape with a cylindrical saddle pocket 44 at the bottom of the saddle 40, i.e. at the point of the cone-shaped saddle.

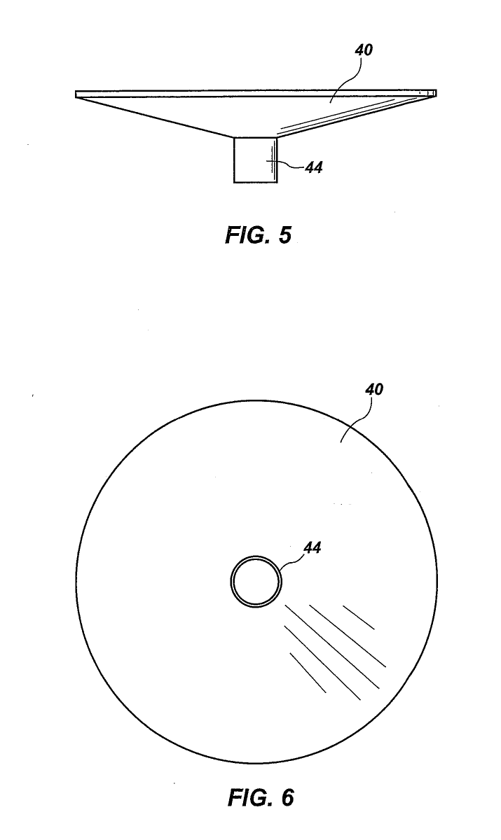

Referring to FIG. 6, a transferable saddle 40 is shown from the bottom to illustrate an embodiment of the saddle that is somewhat circular and includes a cylindrical saddle pocket 44 in the approximate center of the circular shape. The cylindrical saddle pocket 44 may be configured to fit onto the support peg 42, or saddle peg 42, and/or to help secure the saddle 40 on the stem surface 38 in a configuration that allows the saddle 40 to be removable from the stem 30, or stem surface 38, of the support stand 10.

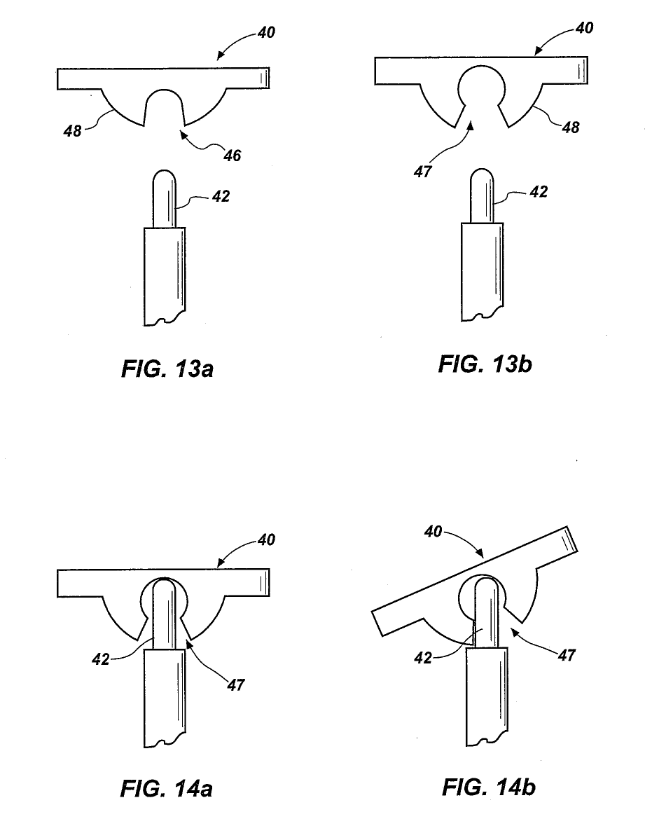

In a separate embodiment, as shown more particularly in FIG. 13a, an indentation, hole, or slot may form a conical saddle pocket 46, which may have a beveled or angled or bell-shaped shape or configuration, and a convex saddle base 48, which may have a hemispherical, rounded, or convex shape or configuration. A convex saddle pocket 46 may be configured to fit onto a saddle peg 42, or support peg 42, including a rounded saddle peg 42, in a manner that allows the transferable saddle 40 to wobble, rotate, tilt, swivel, angle, pivot, or the like, and remain removable from the stem 30, and/or stem surface 38, of the support stand 10.

In a separate embodiment, as shown more particularly in FIG. 13b, an indentation, hole, or slot may form a mushroom saddle pocket 47, which may have a mushroom shape, or a flared keyhole shape in cross-section, and have a convex saddle base 48. Such a mushroom saddle pocket 47 may be configured to fit onto a saddle peg 42, or support peg 42, including a rounded saddle peg 42, in a manner that allows the saddle 40 to wobble, rotate, tilt, swivel, angle, pivot, or the like, and still remain removable from the stem 30, and/or stem surface 38, of the support stand 10.

The term “saddle pocket” may describe a variety of saddle pocket shapes or configurations, including without limitation, a cylindrical saddle pocket 44, a conical saddle pocket 46, and a mushroom saddle pocket 47. The term “beveled saddle pocket” may describe a variety of saddle pocket shapes or configurations that allow the saddle 40 to wobble, tilt, swivel, etc., when removably connected to a support peg 42, including without limitation, a conical saddle pocket 46 and a mushroom saddle pocket 47. Thus, the term “beveled saddle pocket” may include any saddle pocket configuration that allows or enables the wobble as described between the saddle 40 and the support peg 42.

Thus, the transferable saddle 40 is configured to be securely useable with both a support stand 10 and a lifting device 50, and the saddle 40 is also configured to be removable from both the support stand 10 and the lifting device 50. The saddle 40 is also transferable between the support stand 10 and the lifting device 50.

The support stand 10 is configured to work in conjunction with a lifting device, including without limitation, an hydraulic jack, a screw jack, or the like. Lifting devices can come in a variety of configurations and utilize various means for operation. In order to operate as intended with a support stand 10 as described, a lifting device should be compatible with a removable, transferable saddle 40, as described herein, when lifting or elevating a load or vehicle.

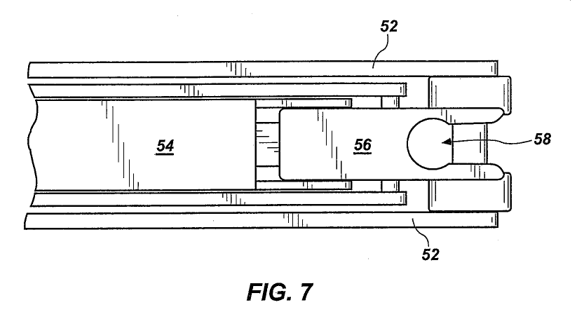

Referring to FIG. 7, in one embodiment, a lifting device or jack may include jack supports 52 that are configured to rest on the ground and provide the necessary support for the jack. A lifting device may include a jack arm 54 that provides the primary lifting structure in conjunction with the jack. A jack arm 54 may include a jack head 56 that is pivotally connected to the jack arm 54. A jack head 56 may include a jack head aperture 58 that is configured to interact with the saddle 40, or more specifically with a saddle pocket, in a manner that allows the saddle 40 to be secure and yet removable with respect to the jack head 56.

In one embodiment, as shown more particularly in FIG. 12, a jack head 56 may include a concave bowl 57, or depression area, or the like. Such a jack head 56 may be configured to facilitate a transferable saddle 40 with a rounded or convex bottom of the saddle 40, or convex saddle base 48, fitting into the concave bowl 57 of the jack head 56, while still providing a jack head aperture 58 to interact with the saddle 40 and accommodate the saddle peg 42.

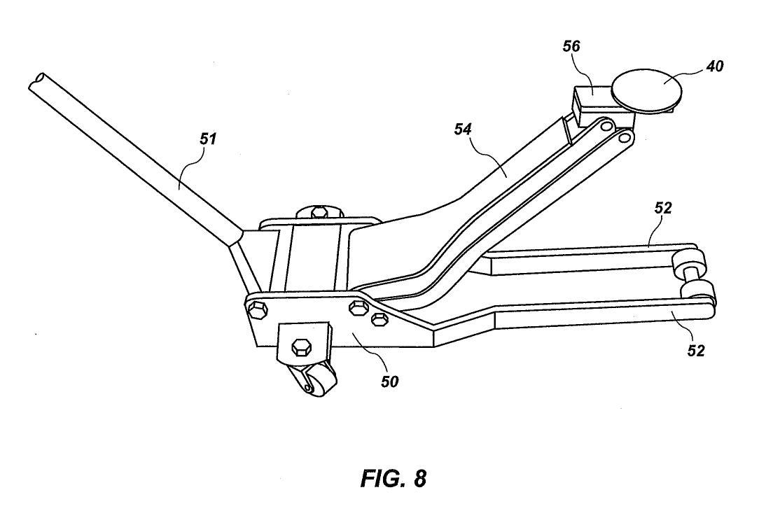

Referring to FIG. 8, a lifting device 50, or jack 50, may include all the necessary components to make the jack 50 operable in its normal, intended manner, for example and not by way of limitation, a jack handle 51 for operating the jack 50, jack supports 52 for providing support structure on the ground, a jack arm 54 for providing a primary lifting structure with the jack 50, a jack head 56 for providing a engagement surface and a structure that enables removable connection with the transferable saddle 40. A number of commercially available jacks may be utilized with the support stand 10 described herein as long as the jack head 56, or corresponding structure on any other type of jack, can be configured to allow for and enable removable connection with a transferable saddle 40.

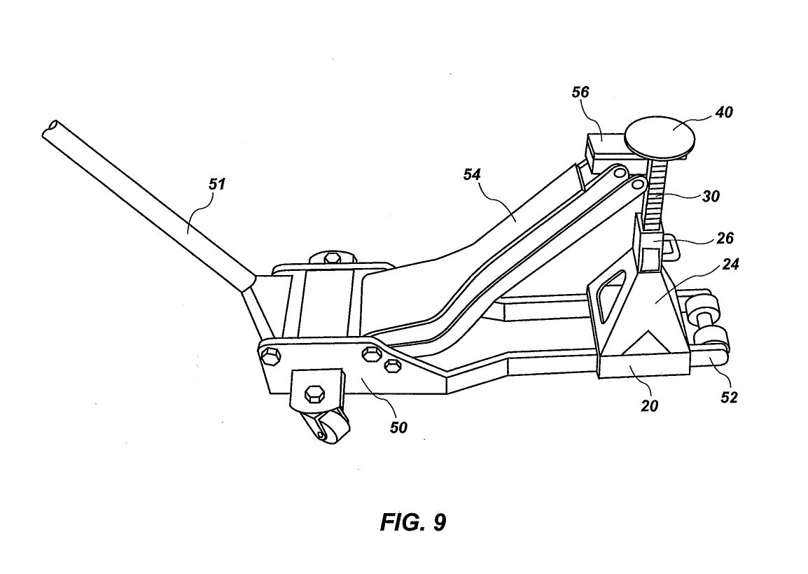

Referring to FIG. 9, a jack 50 is shown with its component parts and also with a support stand 10 positioned under the lifting point of the jack 50, basically at the jack head 56. The base 20 of the support stand 10 is straddling both of the jack supports 52, or in other words, the jack supports 52 are within the base alley 22 with the faces of the base 20 on the outside of the jack supports 52. Any configuration of base 20, or base alley 22, would be suitable as long as it allows the support stand 10 to be positioned appropriately, support the weight of the load, and allow for the removal of the jack 50 once the load has been transferred from the jack 50 to the support stand 10.

In one embodiment, and referring to FIGS. 5, 6, 12, 13, and 14, a stem 30 is positioned under the jack head 56 in a manner that allows the saddle peg 42 to engage the saddle pocket as soon as the jack head 56 is lowered. As the load on the saddle 40 engages the support peg 42, stem 30, or stem surface 38, the load is transferred from the jack 50 to the support stand 10. More specifically, as the load is lowered and the saddle pocket engages the support peg 42, or saddle peg 42, the jack head 56 can be removed from beneath the saddle 40, thus transferring the load from the jack 50 to the support stand 10, all while the load remains resting on the top of the transferable saddle 40.

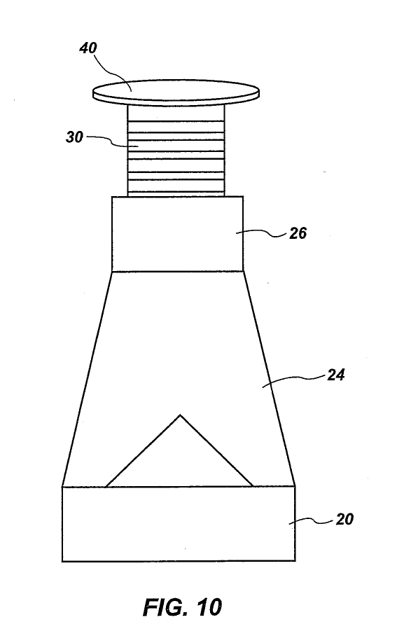

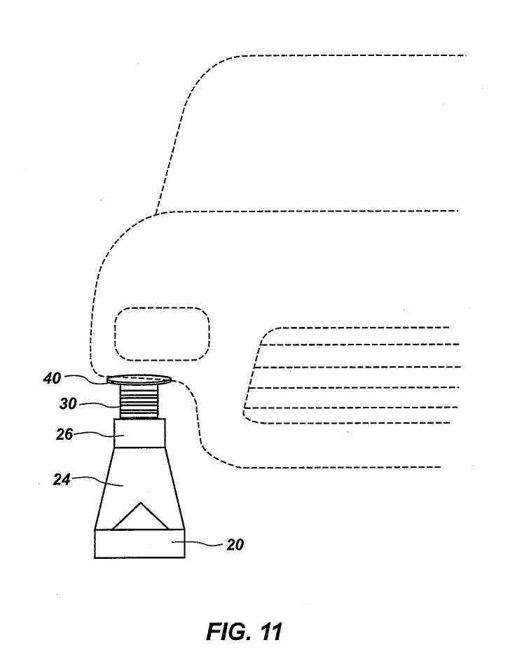

Referring to FIG. 10, the support stand 10 is shown by itself as the jack 50 has been withdrawn. Similarly, referring to FIG. 11, the support stand 10, or saddle 40/support stand 10 configuration, is shown supporting a vehicle (in ghost), or any load.

A method may be employed to safely and conveniently lift a load using a jack 50 outfitted with a removable saddle 40 and then transfer to the load from the jack 50 to a support stand 10. The method may be reversed to safely and conveniently lower the load back to its original position.

A jack 50 with its jack arm 54, or corresponding structure, in its lowest position may be positioned under a load so as to lift the load at a specified lift point. Similarly, a saddle 40 removably connected to a jack head 56, which jack head 56 is pivotally connected to a jack arm 54, may be positioned directly under a specified lift point. With a saddle 40 positioned directly under the specified lift point, the jack 50 may be operated so as to the lift or elevate the load so that the saddle 40 engages the lift point and the load rests safely on the saddle 40. Also, the jack 50 is used to lift the load high enough to allow a support stand 10 to be placed under the saddle 40.

In one embodiment, and referring to FIGS. 5 and 6, a support stand 10 may be positioned under the saddle 40 so that a saddle pocket will engage a saddle peg 42 as soon as the load is lowered. In certain embodiments, the rim of the saddle pocket may also come to rest on the stem surface 38 as the load is lowered. Thus, the load may be transferred from the combination of the saddle 40 and the jack head 56 to the combination of the saddle 40 and the stem 30, utilizing peg 42 and/or stem surface 38, all while the saddle 40 remains engaged with the same lift point and the saddle 40 remains essentially stationary.

As soon as the rim of the saddle pocket sufficiently engages the stem surface 38 or support peg 42, effectively transferring the load from jack 50 to the support stand 10, the jack head 56 may be removed from beneath the saddle 40. Jack 50 may then be removed from the system comprised of the support stand 10 and saddle 40, to be used elsewhere as desired.

Similarly, as the load rests on the combination of the saddle 40 and the support stand 10, the jack head 56 may be inserted beneath the saddle 40. Then the jack 50 may be operated to lift the jack arm 54 and thereby transfer the load from the combination of the saddle 40 and the support stand 10 back to the combination of the saddle 40 and the jack head 56, all while the saddle 40 remains engaged with the same lift point and the saddle 40 remains essentially stationary.

Then, the load may be lowered to the ground and the saddle 40 is allowed to disengage the lift point.

In another embodiment, substantially the same procedure can be performed using a system that includes a saddle 40 with a beveled saddle pocket and rounded bottom of a convex saddle base 48 used in conjunction with a jack head 56 that includes a concave bowl 57, and a stem 30 that may have a rounded saddle peg 42. When a saddle 40 having a beveled saddle pocket is used with a first lift point of a load, it allows the saddle 40 to wobble, pivot or swivel, especially when the load is being lifted at a second lift point, which may cause a support stand 10 to tilt, tip, or rotate. A beveled saddle pocket helps keep the saddle 40 in contact with a first lift point of a load and allows the saddle 40 and load to essentially tilt or tip in unison, which helps reduce or eliminate structural damage that may occur near the first lift point if the load tilts or tips and the saddle 40 remains substantially horizontal.

Referring to FIG. 12, a system or collection of components, is shown, which system may be used to lift and support a load using the same lift point on the load during the entire process. FIG. 12a shows one embodiment of a transferable saddle 40 wherein the saddle 40 includes a conical saddle cup 46 and a rounded, convex saddle base 48. FIG. 12b shows one embodiment of a jack 50 that includes a jack head 56 having a concave bowl 57 in conjunction with a jack head aperture 58. FIG. 12c shows a saddle peg 42 on stem 30 from a jack stand 10.

The convex saddle base 48 of the saddle 40 fits into the concave bowl 57 of the jack head 56. The fit between the saddle base 48 and concave bowl 57 is such that the saddle 40 will not become detached from the jack head 56 while the jack 50 is lifting or elevating a load, but the saddle 40 may be allowed to pivot or tilt as the saddle 40 engages the load.

The conical saddle cup 46 of the transferable saddle 40 fits over the saddle peg 42 and allows the saddle 40 to wobble, tilt, rotate, or pivot in a manner that maintains engagement of the saddle 40 with the lift point of the load, even when the position of the load may change, i.e., when one side of the load is elevated or supported and the other side of the load is being lifted.

Referring to FIG. 13, different embodiments of a transferable saddle 40 are shown. FIG. 13a shows a transferable saddle 40 having a convex saddle base 48 and a bell-shaped, conical saddle cup 46. FIG. 13b shows a transferable saddle 40 having a convex saddle base 48 and a flared keyhole-shaped pocket, or mushroom saddle pocket 47. Both configurations of a transferable saddle 40 as shown may fit onto a saddle peg 42 in a manner that allows the saddle 40 to wobble, tilt, rotate, or pivot and allow the saddle 40 to maintain more contact with the lift point of a load over the upper surface of the saddle 40.

Referring to FIG. 14, a transferable saddle 40 having a flared keyhole-shaped pocket, or mushroom saddle pocket 47, is shown in different tilted positions. FIG. 14a shows a saddle 40 with a mushroom saddle pocket 47 where the saddle 40 is on a saddle peg 42 and the saddle 40 is in a substantially perpendicular, horizontal position with respect to the saddle peg 42. In such a position, the saddle 40 may wobble, tilt, rotate, or pivot to a certain degree, thereby allowing the saddle 40 to maintain more connection with a lift point of a load. FIG. 14b shows a saddle 40 with a mushroom saddle pocket 47 where the saddle 40 is on a saddle peg 42 and the saddle 40 is tilted with respect to the saddle peg 42. In such a position, the edge of the mushroom saddle pocket 47 makes contact with the side of the saddle peg 42 and prevents the saddle from wobbling or tilting too far. As shown more particularly in FIG. 14b, a saddle 40 may also be configured to allow for a limited amount of wobble, tilt, rotation and/or pivoting, thus maintaining a degree of rigidity to the system. Put another way, the saddle 40, or its beveled saddle pocket, is configured to disallow so much wobble, tilt, rotation and/or pivoting that a load could unintentionally slip off the saddle 40, or become disengaged from the saddle 40.

Enabling the saddle 40 to wobble or tilt as described herein helps prevent damage to the lift point, or other structure, of a load or vehicle. When a vehicle is lifted or supported, a jack head and/or jack stand may engage the lift point at an angle. This can cause structural damage to the lift point, or other structure, of a load or vehicle, especially when a load or vehicle is lifted repeatedly. A transferable saddle 40 that can wobble or tilt while on a jack head 56 with a concave bowl 57 and while on a saddle peg 42 helps to prevent damage to a lift point by maintaining more contact between the flat surface of the saddle 40 and the lift point.

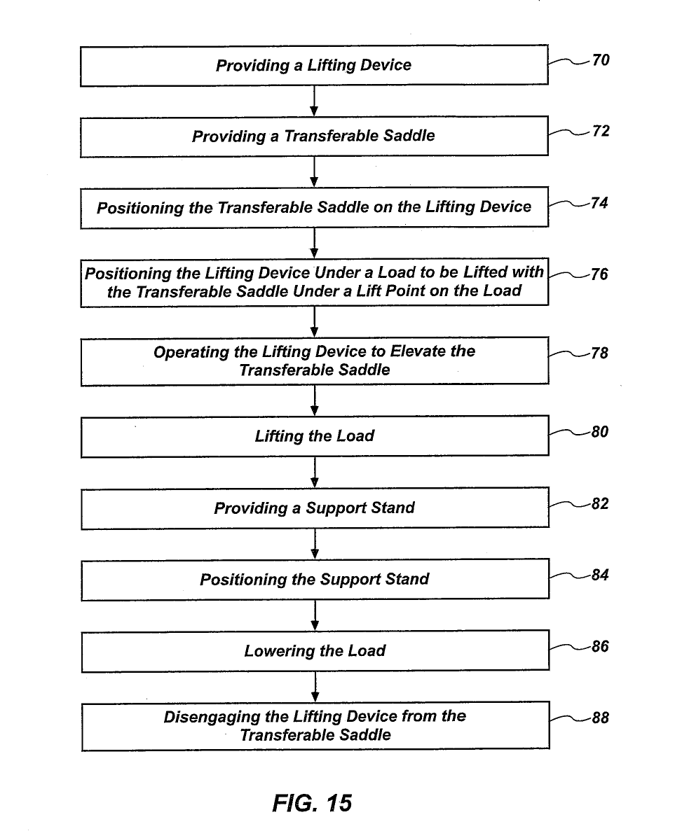

Referring to FIG. 15, a system as described herein may be used to lift and support a load utilizing the same lift point on the load throughout the process of lifting and supporting.

A suitable lifting device may be provided 70. For example, the lifting device 50 may comprise a jack head 56, and the jack head 56 may comprise a concave bowl 57 and a jack head aperture 58. The jack head 56 of the lifting device 50 may be configured to removably engage a transferable saddle 40. The jack head aperture 58 may extend to the bottom of the concave bowl 57, thus allowing the jack head 56 to be separated or disengaged from the saddle 40, for example, when the saddle 40 is sitting on or engaged with a support peg 42 from a support stand 10.

A suitable transferable saddle may be provided 72. For example, the transferable saddle 40 may comprise a convex saddle base 48 and a beveled saddle pocket. A suitable transferable saddle 40 may also comprise a mushroom saddle pocket. The term “saddle pocket” may describe a variety of saddle pocket shapes or configurations, including without limitation, a cylindrical saddle pocket 44 (which may be configured to include a cylindrical hole or opening), a conical saddle pocket 46 (which may be configured to include a conical or bell shaped hole or opening), and a mushroom saddle pocket 47 (which may be configured to include a mushroom or flared keyhole shaped hole or opening). The term “beveled saddle pocket” may describe a variety of saddle pocket shapes or configurations that allow the saddle 40 to wobble, tilt, swivel, etc., when removably connected to a support peg 42, including without limitation, a conical saddle pocket 46 and a mushroom saddle pocket 47. Thus, the term “beveled saddle pocket” may include any saddle pocket configuration that allows or enables the wobble as described between the saddle 40 and the support peg 42.

The transferable saddle may be positioned 74 on the jack head of the lifting device. The transferable saddle 40 may be positioned on the jack head 56 of the lifting device 50 by placing the convex saddle base 48 of the saddle 40 within the concave bowl 57 of the jack head 56. The transferable saddle 40 may be able to wobble, tilt, rotate and/or pivot to a certain degree while the transferable saddle 40 is engaged with the jack head 56 in this manner. At least a portion of the saddle pocket, or beveled saddle pocket, of the transferable saddle 40 will be aligned with at least a portion of the jack head aperture 58 which extends into the concave bowl 57. A jack head 56 of this type is shown more particularly in FIG. 12b.

The lifting device may be positioned 76 under a load to be lifted, and the transferable saddle 40 engaged with the jack head 56 may be positioned 76 under a lift point on the load. The load may be any type of load that requires lifting and/or support, including without limitation, a car, a truck, a trailer, or the like.

The lifting device may be operated 78 in a manner that lifts or elevates the transferable saddle 40. The lifting device 50 may be operated so that the transferable saddle engages or contacts the specified, or intended, lift point of the load. The load may be lifted 80, including without limitation, enough to raise the load off the ground or enough to simply lighten the load or decrease the force or weight of the load. For example, a car may be lifted enough that the tires are completely off the ground, or a car may be lifted enough to decrease the weight of the car on the tires without the tires losing contact with the ground.

A suitable support stand may be provided 82. For example, the support stand 10 may comprise a support peg 42. A suitable support peg 42 may be of any shape, length or cross-section that allows for removable engagement with a saddle pocket, including at least beveled saddle pockets. A support stand 10 may be of any suitable size, shape or configuration, as somewhat described previously herein. A support stand 10 may include any mechanism that enables adjusting the overall height of the support stand, as somewhat described previously herein.

The support stand may be positioned 84 under the jack head 56. For example, the support stand 10 may be positioned under the jack head 56 in a manner that allows the support peg 42 to go through the jack head aperture 58 and engage a saddle pocket, such as a mushroom saddle cup 47 (as shown more particularly in FIG. 14a). A support stand 10 that can engage a variety of saddle pockets may be used in a similar manner, depending on the desired configuration of the transferable saddle 40.

The load may be lowered 86 onto the saddle 40/support stand 10 configuration. For example, the lifting device 50 may be operated to lower the load in a manner that engages a saddle pocket, or beveled saddle pocket, with the support peg 42. This will effectively transfer the weight of the load from the saddle 40/jack head 56 configuration to the saddle 40/support stand 10 configuration. This transfer of the load from the lifting device 50 to the support stand 10 may thus be accomplished while the transferable saddle 40 remains engaged with, or in contact with, the same lift point on the load throughout the process.

In those embodiments where a transferable saddle 40 having a beveled saddle pocket is used, the saddle 40 may tilt, wobble, rotate and/or pivot when the load is lowered depending on the angle of the load throughout the process. This may allow more of the surface area of the saddle 40 to remain in contact with the lift point of the load throughout the process. This may be helpful in preventing or eliminating dents or damage to a load that is lifted numerous times, and eliminate lateral loading of a support device 10, as previously described. As shown more particularly in FIG. 14b, a saddle 40 may also be configured to allow for a limited amount of wobble, tilt, rotation and/or pivoting, thus maintaining a degree of rigidity to the system. Put another way, the saddle 40, or its beveled saddle pocket, is not configured to allow so much wobble, tilt, rotation and/or pivoting that a load could unintentionally slip off the saddle 40, or become disengaged from the saddle 40.

The tilting of wobbling of the transferable saddle 40 while the load is being lowered could result in the transferable saddle essentially locking into place and not allowing further tilting, as shown more particularly in FIG. 14b. The edge of a mushroom saddle pocket 47, or beveled saddle pocket, may contact, or lock against, the side of a support peg 42.

The lifting device may be disengaged 88 from the transferable saddle. For example, the lifting device 50 may disengage from the transferable saddle 40 as the jack head 56 lowers away from the saddle 40, and the jack head aperture 58 allows disengagement of the lifting device 50 from the saddle 40/support stand 10 configuration.

The steps described herein may be repeated to further lift and/or support the same load. For example, this system or method may be used to lift and support the front end of a car, with both front tires off the ground, thereby making it easier to perform repairs or maintenance on the car. The same lifting device 50 may be used repeatedly, especially a lifting device that includes a suitable jack head 56 for engagement with a suitable transferable saddle 40. Additional transferable saddles 40, in any desired configuration, and additional support stands 10 with suitable support pegs 42 will be required. Generally, a suitable transferable saddle 40 and a suitable support stand 10 will be required for each desired lift point of a load.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A support stand apparatus comprising:
a trunk of a support stand;
a support peg connected to the trunk and configured to allow removable connection to a beveled saddle pocket of a transferable saddle;
the beveled saddle pocket configured to allow the transferable saddle to wobble while the beveled saddle pocket is removably connected to the support peg; and
the transferable saddle configured to engage a lift point of a load.

2. The support stand apparatus of claim 1 wherein the transferable saddle further comprises a convex saddle base.

3. The support stand apparatus of claim 2 wherein the beveled saddle pocket is a mushroom saddle pocket.

4. The support stand apparatus of claim 2 wherein the trunk further comprises means for adjusting the overall height of the support stand.

5. A method for transferring a load from a lifting device to a support stand, the method comprising:
providing a lifting device, wherein the lifting device comprises a jack head, and the jack head comprises a concave bowl and a jack head aperture;
providing a transferrable saddle, wherein the transferable saddle comprises a convex saddle base and a beveled saddle pocket;
positioning the transferable saddle on the jack head such that the convex saddle base is positioned in the concave bowl;
positioning the transferable saddle under a lift point on a load to be lifted;
operating the lifting device to elevate the transferable saddle so the transferable saddle engages the lift point;
lifting the load;
providing a support stand comprising a support peg;
positioning the support peg of the support stand under the beveled saddle pocket of the transferable saddle; and
lowering the load onto the support stand by removably connecting the beveled saddle pocket of the transferable saddle and the support peg.

6. The method of claim 5 further comprising disengaging the lifting device from the transferable saddle.

7. The method of claim 5, wherein the beveled saddle pocket is a mushroom saddle pocket.

8. The method of claim 5, wherein the step of positioning the transferable saddle on the jack head further comprises allowing the transferable saddle to wobble while on the jack head.

9. The method of claim 5, wherein the step of lowering the load further comprises wobbling of the transferable saddle as the load is lowered.

10. The method of claim 7, wherein the step of lowering the load further comprises wobbling of the transferable saddle as the load is lowered.

11. The method of claim 10, wherein the step of lowering the load further comprises the wobbling of the transferable saddle resulting in a locking of the transferable saddle.

12. The method of claim 5, wherein the support stand further comprises means for adjusting the overall height of the support stand.

13. The method of claim 5, wherein the support stand is a monolithic, contiguous unit.

14. The method of claim 5, wherein the support stand is configured to straddle at least a portion of the lifting device.

15. A method for transferring a load from a lifting device to a support stand, the method comprising:
providing a lifting device, wherein the lifting device comprises a jack head, and the jack head comprises a concave bowl and a jack head aperture;
providing a first transferrable saddle, wherein the first transferable saddle comprises a first convex saddle base and a first beveled saddle pocket;
positioning the first transferable saddle on the jack head such that the first convex saddle base is positioned in the concave bowl in a manner that allows the first transferable saddle to tilt and rotate while on the jack head and the first beveled saddle pocket is aligned with at least a portion of the jack head aperture;
positioning the lifting device under a load to be lifted such that the first transferable saddle on the jack head is positioned under a first lift point on the load;
operating the lifting device to elevate the first transferable saddle so that the first transferable saddle engages the first lift point;
lifting the load;
providing a first support stand comprising a first support peg;
positioning the first support peg of the first support stand under the first beveled saddle pocket of the first transferable saddle;
lowering the load onto the first support stand by removably connecting the first beveled saddle pocket and the first support peg in a manner that results in some tilting of the first transferable saddle; and
disengaging the lifting device from the first transferable saddle.

16. The method of claim 15 further comprising:
providing the lifting device;
providing a second transferable saddle, wherein the second transferable saddle comprises a second convex saddle base and a second beveled saddle pocket;
positioning the second transferable saddle on the jack head such that the second convex saddle base is positioned in the concave bowl in a manner that allows the second transferable saddle to tilt and rotate while on the jack head and the second beveled saddle pocket is aligned with at least a portion of the jack head aperture;
positioning the lifting device under the load such that the second transferable saddle on the jack head is positioned under a second lift point on the load;
operating the lifting device to elevate the second transferable saddle so that the second transferable saddle engages the second lift point;
lifting the load;
providing a second support stand comprising a second support peg;
positioning the second support peg of the second support stand under the second beveled saddle pocket of the second transferable saddle;
lowering the load onto the second support stand by removably connecting the second beveled saddle pocket and the second support peg in a manner that results in some tilting of the second transferable saddle; and
disengaging the lifting device from the second transferable saddle.

17. The method of claim 16, wherein the support stand and the second support stand both further comprise means for adjusting a first and second height of both support stands, respectively.

18. The method of claim 17, further comprising:
after the positioning the first support peg of the first support stand, adjusting the first height of the first support stand; and
after the positioning the second support peg of the second support stand, adjusting the second height of the second support stand.

19. The method of claim 16, wherein the first beveled saddle pocket is a first mushroom saddle pocket and the second beveled saddle pocket is a second mushroom saddle pocket.

20. The method of claim 18, wherein the step of lowering the load further comprises the tilting of the first transferable saddle resulting in a locking of the first transferable saddle.
